(19) United States
(12) Patent Application Publication
(10) Pub. No.: US 2011/0127139 A1
(43) Pub. Date: Jun. 2, 2011

(54) WAFER CONVEYING AND DETECTING SYSTEM AND WAFER DETECTING METHOD USED IN WAFER CONVEYING AND DETECTING SYSTEM

(76) Inventor: Chih-hao Huang, Hsinchu City (TW)

(21) Appl. No.: 12/785,548

(22) Filed: May 24, 2010

(30) Foreign Application Priority Data
Nov. 30, 2009 (TW) 098140802

(51) Int. Cl. B65G 49/06

(52) U.S. Cl. 198/339.1

(57) ABSTRACT

The present invention discloses a wafer conveying and detecting system and wafer detecting method used in the wafer conveying and detecting system. The wafer conveying and detecting system comprises a first conveying unit, a second conveying unit, a detection unit and a transmission mechanism. The first conveying unit transfers wafers to the second conveying unit, and the detection unit is moved by the transmission mechanism relative to the second conveying unit to detect the wafers at the second conveying unit when the second conveying is stopped temporarily.

### FIELD OF THE INVENTION

The present invention is related to wafer transferring and detecting technology and more specifically, to a wafer conveying and detecting system, which moves a detection unit relative to the second conveying units to detect wafers at the second conveying unit when the second conveying unit is stopped temporarily, thereby enhancing wafer detection accuracy.

### BACKGROUND

During wafer fabrication, fabricated wafers may be detected, for example, it may be necessary to detect the structure, circuit connection and printing of fabricated wafers. Further, to enhance wafer examination efficiency, fabricated wafers are detected during transfer.

FIG. 1 illustrates a wafer conveying and detecting system according to the prior art. As illustrated, the wafer conveying and detecting system 10 comprises a conveying belt 11 and a detection unit 13. The detection unit 13 is an area type detection unit 13 arranged above the conveying belt 13. For example, a bracket 15 is provided to connect the conveying belt 11 and the detection unit 13.

The conveying belt 11 is adapted to transfer wafers 12. Because the detection unit 13 is arranged above the wafer transferring path, it can detect wafers 12 being transferred by the conveying belt 11. Because the detection unit 13 detects wafers 12 when wafers 12 are being transferred by the conveying belt 11, wafer detection time is shortened.

By means of the application of the aforesaid wafer conveying and detecting system 10, fabricated wafers 12 are detected within a short time. Further, because the detection unit 13 is an area type detection unit, it can detect wafers 12 or pick up the images of wafers 12 in a big area. The detection unit 13 can be an image sensor. The detecting area A1 of the detection unit 13 is greater than the area of one wafer 12. Thus, the detection unit 13 can detect one wafer 12 or pick up the image of one wafer 12 through one single action.

Although the detection unit 13 can detect wafers 12 rapidly, however the detection unit 13 may pick up a distorted image during transfer of the wafer 12 by the conveying belt 11, and the resolution of the image obtained may be low, for example, the edge area of the image obtained may be distorted, lowering the detection accuracy.

### SUMMARY OF THE PRESENT INVENTION

It is, therefore, the main object of the present invention to provide a wafer conveying and detecting system, which enables the detection unit to be moved by a transmission mechanism so that the detection unit can scan and detect immovable wafers, improving detection accuracy and wafer image clarity,

It is another object of the present invention to provide a wafer conveying and detecting system, which uses a second conveying unit to carry and transfer wafers, and drives the detection unit to detect wafers at the second conveying unit when the second conveying unit is stopped temporarily, avoiding interference of vibrations and improving detection accuracy.

It is still another object of the present invention to provide a wafer conveying and detecting system, which uses a high stable transmission mechanism to move the detection unit relative to the second conveying unit, enhancing detection stability.

It is still another object of the present invention to provide a wafer conveying and detecting system, which uses a linear detection unit to detect wafers and a transmission mechanism to move the linear detection unit relative to the detect wafers, avoiding image distortion.

It is still another object of the present invention to provide a wafer conveying and detecting system, which uses a linear detection unit to detect wafers instead of a face type detection unit, saving the cost.

It is still another object of the present invention to provide a wafer conveying and detecting system, which uses a third conveying unit to transfer inaccurately detected wafers back to the second conveying unit for enabling the detection unit to detect inaccurately detected wafers again, improving detection performance.

To achieve these and other objects of the present invention, a wafer conveying and detecting system comprises a first conveying unit adapted for transferring at lest one wafer, a second conveying unit adapted for receiving and transferring the at least one wafer from the first conveying unit, a detection unit adapted for detecting the at least one wafer at the second conveying unit, and a transmission mechanism connecting with the detection unit and adapted for moving the detection unit relative to the second conveying unit for enabling the detection unit to detect the at least one wafer at the second conveying unit when the second conveying unit is stopped temporarily.

To achieve these and other objects of the present invention, a wafer detecting method is used in a wafer conveying and detecting system comprising a first conveying unit, a second conveying unit, a detection unit and a transmission mechanism. The wafer detecting method comprising the steps of enabling at least one wafer to be transferred by said first conveying unit to said second conveying unit, stopping the second conveying unit temporarily, and driving the transmission mechanism to move the detection unit relative to the second conveying unit and then driving the detection unit to detect the at least one wafer at the second conveying unit.

### BRIEF DESCRIPTION OF THE DRAWINGS

FIG. 1 is a schematic drawing showing a wafer conveying and detecting system according to the prior art.

FIG. 2 is a schematic structural view of a wafer conveying and detecting system in accordance with the present invention.

FIG. 3 is a schematic side view of the wafer conveying and detecting system in accordance with the present invention.

FIGS. 4A˜4F illustrate the wafer-transferring operation flow of the wafer conveying and detecting system in accordance with the present invention.

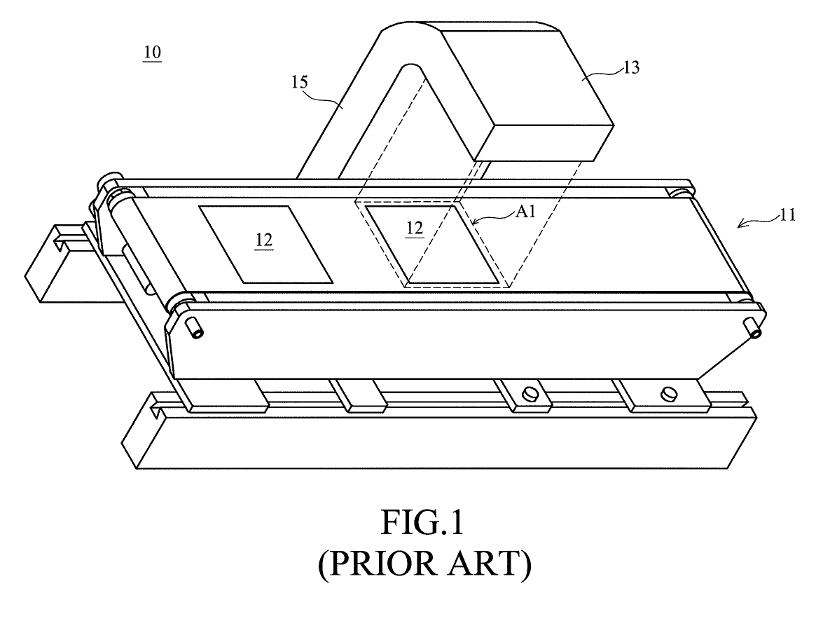

### DETAILED DESCRIPTION OF THE PREFERRED EMBODIMENTS

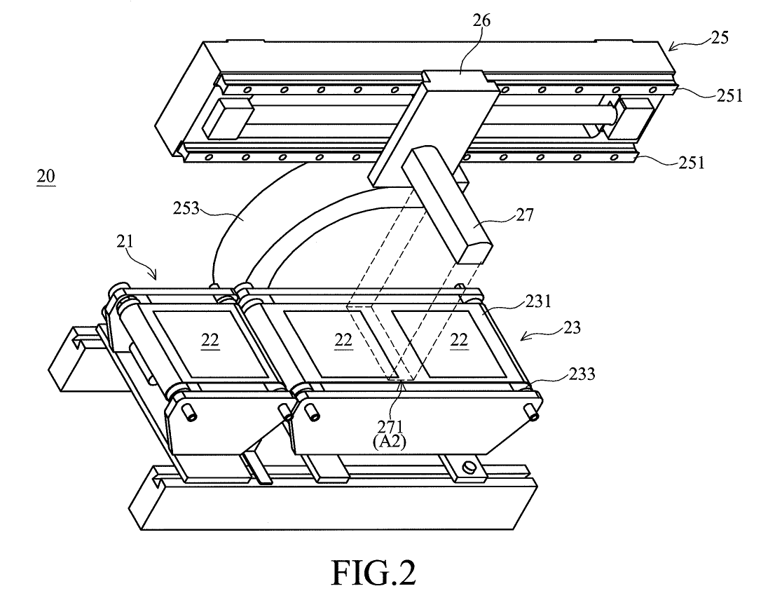

Please refer to FIG. 2. A wafer conveying and detecting system 20 in accordance with the present invention is shown comprising a first conveying unit 21, a second conveying unit 23, a transmission mechanism 25 and a detection unit 27. The first conveying unit 21 is adapted for conveying wafers 22 to the second conveying unit 23 for receiving a wafer 22. The transmission mechanism 25 is adapted for moving the detection unit 27 to detect wafers 22 being carried to the second conveying unit 23.

The first conveying unit 21 and the second conveying unit 23 are conveying belts for conveying wafers 22. The second conveying unit 23 is connected to the first conveying unit 21 for receiving wafers 22 from the first conveying unit 21. The detection unit 27 is connected to the transmission mechanism 25 and movable by the transmission mechanism 25. For example, the transmission mechanism 25 can be disposed at one lateral side or the top side of the second conveying unit 23 for moving the detection unit 27 above the second conveying unit 23 for enabling the detection unit 27 to detect wafers 22 at the second conveying unit 23.

During operation of the wafer conveying and detecting system 20, the first conveying unit 21 delivers wafers 22 one by one to the second conveying unit 23. When the second conveying unit 23 receives one wafer 22 from the first conveying unit 21, it is stopped temporarily to hold the wafer 22 in place. Immediately after pause of the second conveying unit 23, the transmission mechanism 25 moves the detection unit 27 to scan or detect the wafer 22 at the second conveying unit 23, or to fetch the image of the wafer 22 at the second conveying unit 23.

The detection unit 27 is controllable to detect a wafer 22 at the second conveying unit 23. According to one embodiment of the present invention, the detection unit 27 comprises at least one lens and a sensor (charge-coupled device or complementary metal oxide semiconductor). Reflected light or diffused light from the wafer 22 goes through the at least one lens and falls upon the sensor, thus the detection unit 27 fetches the image of the wafer 22. A further image matching procedure may be employed to match the image of the test wafer 22 fetched by the detection unit 27 with a predetermined reference data, finishing the examination of the test wafer 22. For example, the detection unit 27 can be connected to an external computer system (not shown) to transmit the fetched image data of the test wafer 22 to the computer system for enabling the computer system to match the image data of the test wafer 22 with a predetermined reference data, thereby determining the test wafer 22 to be a quality product or defective product.

The detection unit 27 can be a linear detection unit. Normally, the area A2 of the detecting zone 271 of the detection unit 27 is smaller than the area of the test wafer 22. Thus, a relative motion between the detection unit 27 and the test wafer 22 is necessary so that the detection unit 27 can scan the test wafer 22, or fetch the image of the test wafer 22.

According to conventional designs, the detection unit 27 should be immovable, and the second conveying unit 23 will keep conveying wafers 22 over the detecting zone 271 of the detection unit 27 for examination. The second conveying unit 23 is adapted mainly for conveying wafers 22. For the sake of cost casing, the structural precision of the second conveying unit 23 is less critical. According to one embodiment of the present invention, the second conveying unit 23 comprises a conveying belt 231 and at least one drive roller 233. Driving the at least one drive roller 233 rotates the conveying belt 231 to deliver wafers 22. When the second conveying unit 23 is delivering wafers 22, the conveying path may be not kept perfectly straight. Any vibration or variation of conveying speed can cause the delivering wafers 22 to change their moving path. At this time, a detecting error may occur if the detection unit 27 is immovable.

The transmission mechanism 25 is much stable when compared to the first conveying unit 21 or the second conveying unit 23. Thus, the detection unit 27 can be moved stably on the transmission mechanism 25, for example, the transmission mechanism 25 can move the detection unit 27 at a constant speed, avoiding any abnormal vibration during movement of the detection unit 27. Thus, the detection unit 27 can detect the wafer 22 or fetch the image of the test wafer 22 accurately.

In one embodiment of the present invention, the transmission mechanism 25 comprises ar least one track 251 and a driving unit 253. The detection unit 27 is mounted on the track 251 and movable by the driving unit 253 along the track 251. For example, a connection device 26 is used to connect the detection unit 27 to the track 251, allowing the detection unit 27 to be moved with the connection device 26 stably along the track 251.

The second conveying unit 23 can carry one wafer 22 or a plurality of wafers 22 at a time. If the second conveying unit 23 is designed to carry multiple wafers 22 at a time, the number of time in which the transmission mechanism 25 is temporarily stopped during the wafer detecting procedure can be relatively reduced, thereby improving the wafer detecting efficiency. For example, the first conveying unit 21 transfers two pieces of wafers 22 to the second conveying unit 23, and the second conveying unit 23 is stopped temporarily after the two pieces of wafers 22 have been transferred to the detecting zone at the second conveying unit 23. When the second conveying unit 23 is paused, the transmission mechanism 25 moves the detection unit 27 to detect the two pieces of wafers 22 at the second conveying unit 23. It is to be understood that the number of wafers 22 to be placed on the second conveying unit 23 can be greater than 2.

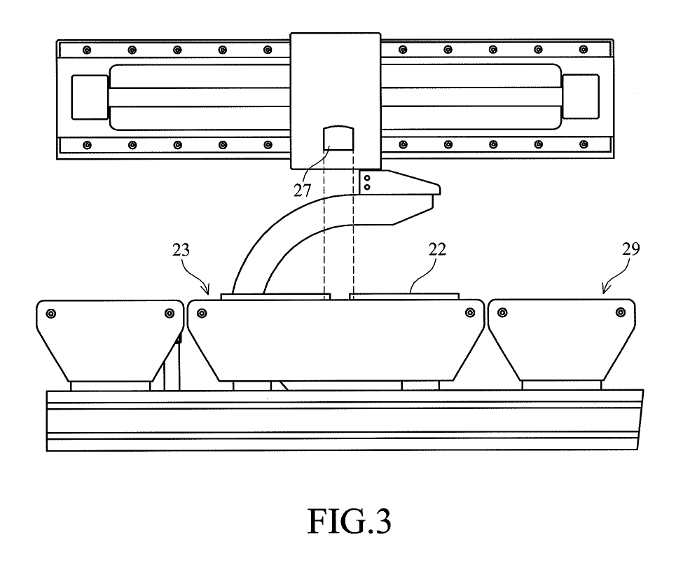

In another embodiment of the present invention as shown in FIG. 3, a third conveying unit 29 is arranged at one end of the second conveying unit 23 opposite to the first conveying unit 21. After examination of the wafer 22, the second conveying unit 23 is started to deliver the detected wafer 22 to the third conveying unit 29. Further, the wafers 22 to be transferred by the first conveying unit 21, the second conveying unit 23 and/or the third conveying unit 28 can be solar cell silicon wafers, and the detection unit 27 is adapted for detecting solar cell silicon wafers,

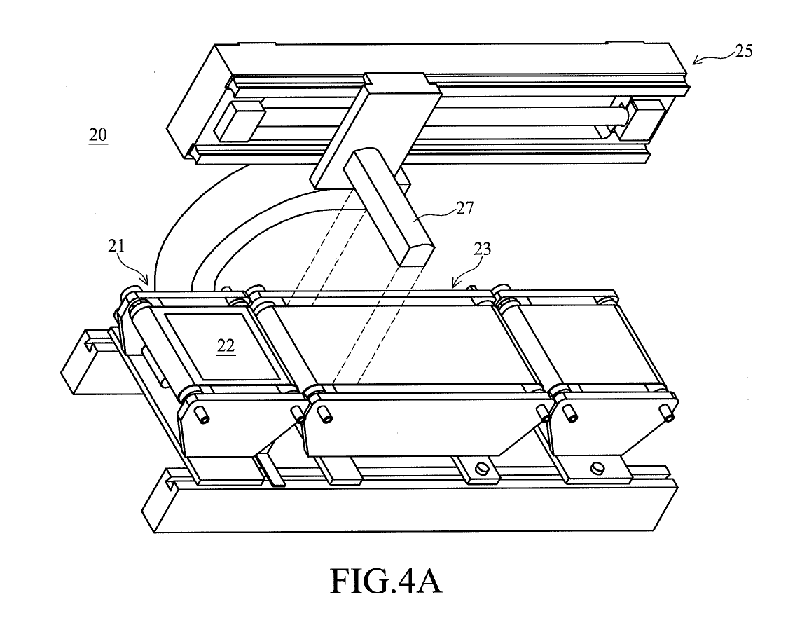

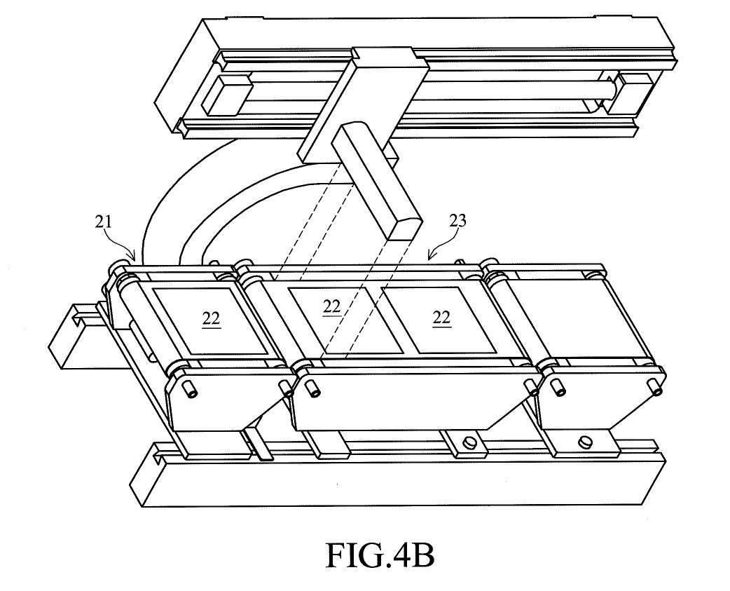

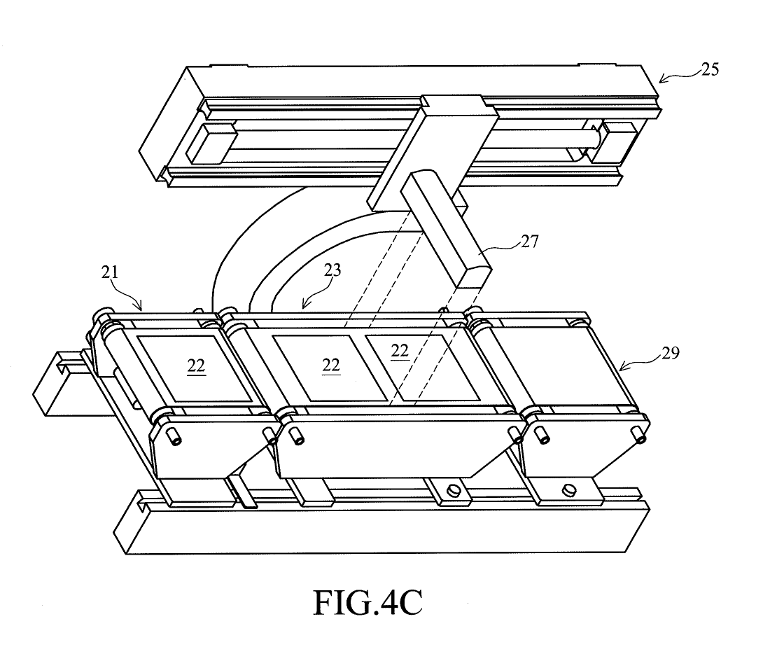

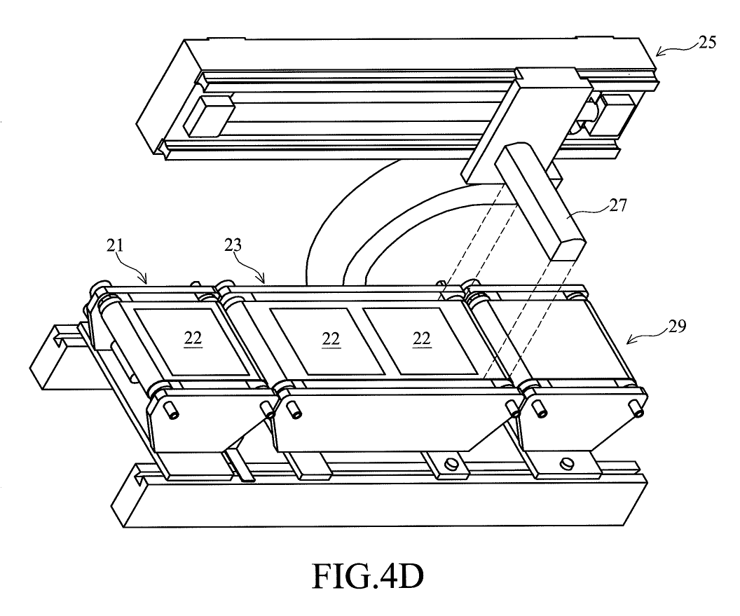

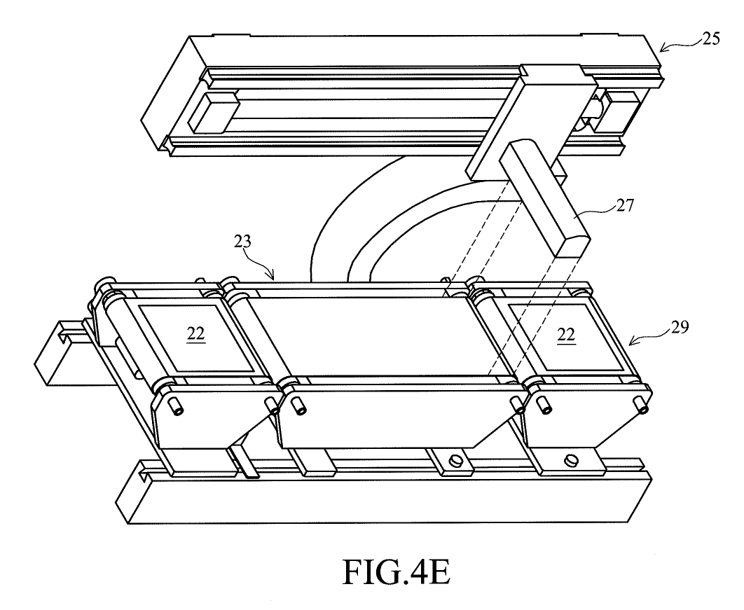

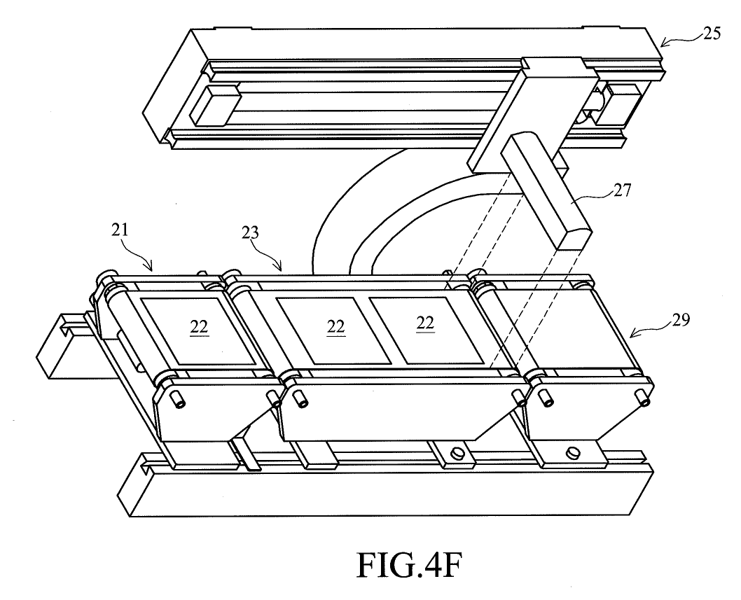

Referring to FIGS. 4A˜4F, the wafer conveying and detecting system 20 comprises a first conveying unit 21, a second conveying unit 23, a transmission mechanism 25 and a detection unit 27, wherein the first conveying unit 21 and the second conveying unit 23 are adapted for conveying wafers 22, and the transmission mechanism 25 is adapted for moving the detection unit 27 relative to the second conveying unit 23 to detect the wafers 22.

The first conveying unit 21 and the second conveying unit 23 are arranged close to each other such that the first conveying unit 21 can transfer at least one wafer 22 to the second conveying unit 23, as shown in FIG. 4A. The second conveying unit 23 receives and carries the wafer 22 from first conveying unit 21. According to this embodiment, the second conveying unit 23 can carry one or a plurality of wafers 22 at the same time, for example, the two pieces of wafers 22 are carried on the second conveying unit 23 at the same time. In another embodiment, the second conveying unit 23 can carry more than two pieces of wafers 22 at the same time. After the first conveying unit 21 transferred two pieces of wafers 22 to the second conveying unit 23, the second conveying unit 23 is stopped temporarily, keeping the two pieces of wafers 22 on the second conveying unit 23, as shown in FIG. 4B.

When the second conveying unit 23 is stopped temporarily, the transmission mechanism 25 is started to move the detection unit 27, enabling the detection unit 27 to scan the two pieces of wafers 22. For example, the transmission mechanism 25 moves the detection unit 27 in direction from the first conveying unit 21 toward the third conveying unit 29, as shown in FIGS. 4C and 4D. The wafer conveying and detecting system 20 is adapted to carry detecting wafers 22 onto the second conveying unit 23 for enabling the detection unit 27 to be moved by the transmission mechanism 25 relative to the still wafers 22. During movement of the detection unit 27, the transmission mechanism 25 is mush stable than the second conveying unit 23, facilitating improvement in the accuracy of the operation of the detection unit 27 in examining the wafers 22.

After the detection unit 27 finished the examination on the wafers 22 at the second conveying unit 23, the transmission mechanism 25 stops the detection unit 27, and the second conveying unit 23 is started again to transfer the detected wafers 22 to the third conveying unit 29, as shown in FIG. 4E. After the second conveying unit 23 transferred the detected wafers 22 to the third conveying unit 29, the first conveying unit 21 is started again to transfer another two pieces of wafers 22 to the second conveying unit 25 for examination by the detection unit 27. For example, the transmission mechanism 25 moves the detection unit 27 in direction from the third conveying unit 29 toward the first conveying unit 21 to detect the two new pieces of wafers 22 at the second conveying unit 23, as shown in FIG. 4F.

Subject to the aforesaid operation procedure, the invention achieves transfer and examination of wafers 22. Further, in another alternate form of the present invention, the second conveying unit 23 receives test wafers 22 from the first conveying unit 21 when transferring detected wafers 22 to the third conveying unit 29.

In one embodiment of the present invention, the third conveying unit 29 can transfer wafers 22 back to the second conveying unit 23 for enabling the detection unit 27 to detect the wafers 22 again. At this time, the first conveying unit 21 stops transferring wafers 22 to the second conveying unit 23. For example, when wafers 22 are transferred by the first conveying unit 21 to the second conveying unit 23, and the transmission mechanism 25 is moving the detection unit 27 to detect the wafers 22 at the second conveying unit 23, the detection unit 27 may be unable to finish examination due to stacking of the wafers 22 or any other reasons. When this problem occurs, the first conveying unit 21 is stopped temporarily, and the conveying direction of the third conveying unit 29 and/or the second conveying unit 23 is changed, enabling the wafers 22 to be transferred from the third conveying unit 29 to the second conveying unit 23 so that the detection unit 27 can detect the wafers 22 again.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wafer conveying and detecting system, comprising:
a first conveying unit adapted for transferring at lest one wafer;
a second conveying unit connecting with said first conveying unit and adapted for receiving the at least one wafer from said first conveying unit; and
a detection unit adapted for detecting the at least one wafer at said second conveying unit; and
a transmission mechanism connecting with said detection unit and adapted for moving said detection unit relative to said second conveying unit for enabling said detection unit to detect the at least one wafer at said second conveying unit when said second conveying unit is stopped temporarily.

2. The wafer conveying and detecting system as claimed in claim 1, further comprising a third conveying unit connected to one end of said second conveying unit opposite to said first conveying unit and adapted for receiving the at least one wafer from said second conveying unit.

3. The wafer conveying and detecting system as claimed in claim 2, wherein said third conveying unit is controllable to transfer the at least one wafer back to said second conveying unit for enabling said detection unit to detect the at least one wafer at said second conveying unit again.

4. The wafer conveying and detecting system as claimed in claim 1, wherein said transmission mechanism comprises at least one track and a driving unit, and said detection unit is movable by said driving unit along said track.

5. The wafer conveying and detecting system as claimed in claim 4, wherein said transmission mechanism further comprises a connection device that connects said detection unit to said track.

6. The wafer conveying and detecting system as claimed in claim 1, wherein each said wafer is a solar cell silicon wafer.

7. The wafer conveying and detecting system as claimed in claim 1, wherein said detection unit is a linear detection unit.

8. The wafer conveying and detecting system as claimed in claim 1, wherein said second conveying unit is adapted to transfer a plurality of said wafers at a time.

9. The wafer conveying and detecting system as claimed in claim 1, wherein said detection unit comprises at least one lens and a sensor.

10. A wafer detecting method used in a wafer conveying and detecting system comprising a first conveying unit, a second conveying unit, a detection unit and a transmission mechanism, the wafer detecting method comprising the steps of:
enabling at least one wafer to be transferred by said first conveying unit to said second conveying unit;
stopping said second conveying unit temporarily; and
driving said transmission mechanism to move said detection unit relative to said second conveying unit and then driving said detection unit to detect the at least one wafer at said second conveying unit.

11. The wafer detecting method as claimed in claim 10, further comprising the step of driving said second conveying unit to transfer the detected at least one wafer to a third conveying unit.

12. The wafer detecting method as claimed in claim 11, wherein said transmission mechanism is controllable to move said detection unit in direction from said first conveying unit toward said third conveying unit.

13. The wafer detecting method as claimed in claim 11, wherein said transmission mechanism is controllable to move said detection unit in direction from said third conveying unit toward said first conveying unit.

14. The wafer detecting method as claimed in claim 11, further comprising the step of driving said third conveying unit to transfer the at least one wafer back to said second conveying unit.

15. The wafer detecting method as claimed in claim 14, further comprising the step of: driving said transmission mechanism to move said detection unit relative to said second conveying unit and then driving said detection unit to detect the at least one wafer at said second conveying unit.

16. The wafer detecting method as claimed in claim 10, wherein said transmission mechanism comprises at least one track and a driving unit adapted for moving said detection unit along said track.

17. The wafer detecting method as claimed in claim 16, wherein said transmission mechanism further comprises a connection device that connects said detection unit to said track.

18. The wafer detecting method as claimed in claim 10, wherein each said wafer is a solar cell silicon wafer.

19. The wafer detecting method as claimed in claim 10, wherein said detection unit is a linear detection unit.

20. The wafer detecting method as claimed in claim 10, wherein said second conveying unit is adapted for carrying a plurality of wafers at a time.
